(19) United States
(12) Patent Application Publication
(10) Pub. No.: US 2021/0247947 A1
(43) Pub. Date: Aug. 12, 2021

(54) Video Routing and Screen Sharing in Multi-Tiered Display Environment

(71) Applicant: Mersive Technologies, Inc., Denver, CO (US)

(72) Inventors: Christopher Jaynes, Denver, CO (US); Josh Svee, Denver, CO (US); Mike Tolliver, Denver, CO (US); Brandon Barron, Denver, CO (US)

(21) Appl. No.: 17/170,444

(22) Filed: Feb. 8, 2021

Related U.S. Application Data
(60) Provisional application No. 62/971,942, filed on Feb. 8, 2020.

(51) Int. Cl. G06F 3/14; H04L 29/06

(52) U.S. Cl. CPC G06F 3/1454; H04L 65/604; H04L 65/4015; H04L 65/403; H04L 65/607

(57) ABSTRACT

A collaborative system and method with video routing and screen sharing includes a plurality of shared displays connected to user computing devices. Content may be shared between users on a single shared display. Additionally, content may be shared between shared displays of different groups and/or a shared display visible to everyone in the room. Connections between computing devices and shared displays may be reconfigured quickly and easily by a teacher or facilitator from a variety of computing devices in a classroom to encourage cross-team comparisons, presentations and sharing using a simple graphical user interface. Embodiments disclosed herein may be used in classroom, business or any organization to facilitate a collaborative working environment.

### CROSS-REFERENCE TO RELATED APPLICATION

This application claims priority to and benefits from U.S. Provisional Application Ser. No. 62/971,942 filed Feb. 8, 2020, the entirety of which is incorporated by reference herein.

### BACKGROUND

Digital infrastructure is used to connect users and their digital devices to each other for communication and sharing of work products. Digital infrastructure is used in many environments, including business, personal and education. It includes, for instance, both computing devices and the networks to which they are connected. Communications may include audio, video, documents, or any type of content that may be created or represented on a digital device.

Users who are working together and their digital devices may be located in the same room or in far-flung geographic locations. Video conferencing room systems are a type of digital infrastructure that may be configured and deployed so that users in a video conference room can leverage the room infrastructure to hold a conference with remote participants. A typical video conferencing room system may have several components, including a display large enough to be viewed by everyone in the room; an audio system such as a standalone microphone, speakers or telephone available for use during a call; a room camera, which typically has a wider field of view and is deployed in the room in a fixed location to support teams of users in the room who want to participate in the meeting; and a codec unit that is responsible for call control (via SIP), audio, and video send (RSTP).

While video conferencing has been widely adopted in business environments, classrooms are also starting to incorporate this technology to facilitate learning, using such items as a computing device or tablet for each student, digital projectors and smart boards. Classroom systems tend to replicate the lecture-style model where a teacher shows content from the teacher's device on a display at the front of the room, while students follow along or interact with content or software individually on their own devices. There is very little opportunity for sharing content other than physically looking at the display of another student.

Other classroom systems may provide a team setup where small groups of students access a shared display with individual devices. Connecting digital devices may use video switching technology requiring a video capture/encode device at each display to convert the content on the display into a routable stream. This system may also use a centralized video switcher which captures and transmits a mirror or replica of a video device's output. Both require cabling and additional hardware/systems. Disadvantages of this approach include the expense of additional hardware, and fixed cabling that makes the room configuration inflexible and unable to respond to changing classroom dynamics.

Prior art systems also require a mechanism to program a user interface based on the number of screens, user-experience rules, and graphical elements. This means that each user interface may be unique from room-to-room and requires specialized programming, both to set up and to use.

An example of a video conferencing system is disclosed in US 2014/0240445, incorporated herein by reference. FIG. 1 is a diagram illustrating exemplary components of a representative video conferencing system 100. As shown in FIG. 1, the present system includes shared display device 102 controlled by a host controller 104 including display software 105. Although only one shared display device 102 is shown in FIG. 1, any number of shared display devices may be included in system 100. Host controller 104 is a computing device that is interconnected with one or more client devices 106, each executing client software 107 to control a local client display 108 and to also control image display on shared display device 102.

Client device 106 includes local memory 110 for temporarily storing applications, context and other current information. Typically, a client host is integrated with a PC, laptop, or a hand-held device such as a smart phone or tablet. Dotted line 120 indicates a network interconnection between client devices 106 and host controller 104, which may be wireless or wired.

### SUMMARY

In embodiments, an active learning system includes hardware and software that facilitates collaboration and discovery between students and teachers using one or more shared displays. Groups of students may collaborate using computing devices connected to a shared display. Additionally, content may be shared between shared displays of different groups and/or a shared display visible to everyone in the room. Connections between computing devices and shared displays may be reconfigured quickly and easily by a teacher or facilitator from a variety of computing devices in a classroom to encourage cross-team comparisons, presentations and sharing using a simple control interface. Embodiments disclosed herein may be used in classroom, business or any organization to facilitate a collaborative working environment.

### BRIEF DESCRIPTION OF THE DRAWINGS

FIG. 1 is a diagram illustrating an exemplary video conferencing system using a shared display, in embodiments.

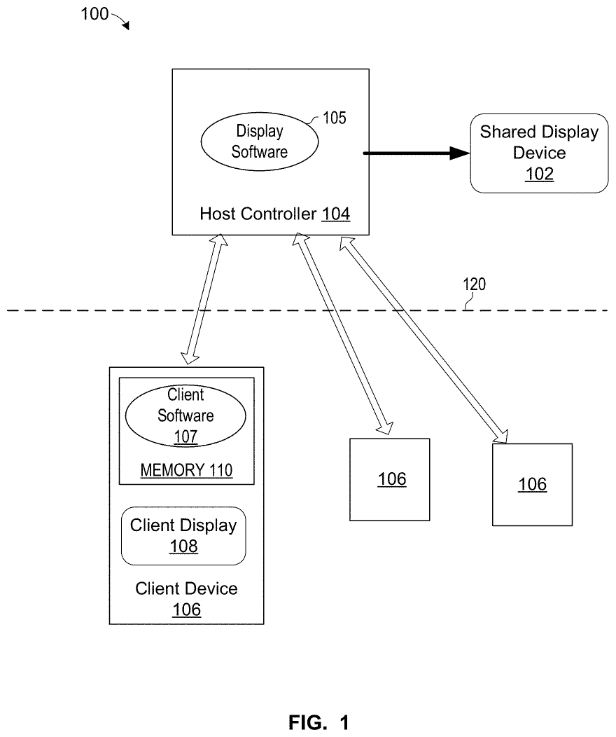

FIG. 2 is a diagram of an active learning room, in embodiments.

FIG. 3 is a block diagram of components of an active learning system, in an embodiment.

FIG. 4 is a diagram of a facility with more than one active learning room, in an embodiment.

FIG. 5 is a representation of a GUI for use by an administrator or facilitator with an active learning facility, in an embodiment.

FIG. 6 is a flowchart illustrating a method of routing video streams using the GUI of FIG. 5, in an embodiment.

### DETAILED DESCRIPTION

As classrooms include more learning activities that use digital devices, students benefit from an ability to share digital content between their individual devices. Embodiments herein are described in terms of an active learning environment in an educational facility, but they are not limited to that use. In addition to educational spaces, systems may be used for business meetings or training, presentation venues or other activities requiring sharing of digital information. It should be further understood that a “room” as used herein generally indicates a physical space with multiple participants, but participants may also be separated geographically but still understood as participating in activities in a room. A room encompasses a tiered set of displays, each shared display connected to a host controller. A group of individual devices may be connected to a host controller so content may be interactively shared and manipulated on the shared display associated with the host controller. In addition, the host controllers are coupled to a network and the content of each shared display may be flexibly shared between shared displays in the room.

A “facilitator” as used herein may encompass an education professional, teacher, moderator, manager, or anyone who is directing the progress of a group activity involving digital content. As used herein, a “facility” is a physical or virtual space encompassing a plurality of active learning environments, or rooms, managed by an administrator using a control application. In embodiments, a facility operates one or more local area networks (LANs) to interconnect various devices. Devices may be both owned or managed by the facility and privately owned by guests, students or employees of the facility. The LAN may be wired, wireless or a combination of both. The LAN may be coupled to the Internet. Individual devices may connect to a host controller through a wired or wireless connection.

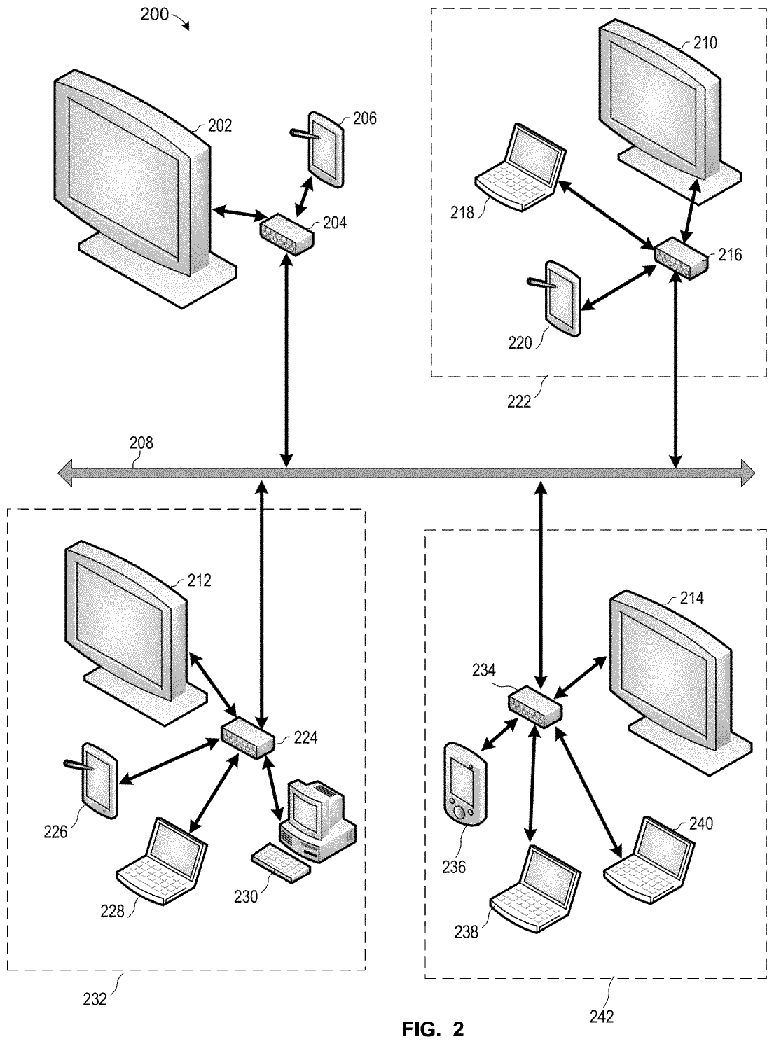

FIG. 2 is a diagram of an active learning environment 200, in embodiments. For clarity, the following description uses terminology of an active learning environment i.e. classroom, but are equally applicable to any collaborative working environment. A primary display 202 is physically located at the front of an active learning space, or more generally in a place where it is visible to everyone in the classroom. In embodiments, shared display may be a flat screen display or a projector and screen, for example. In further embodiments, an active learning environment 200 may not include primary display 202.

Primary display 202 is connected to host controller 204. Host controller 204 is a device including a processor and memory storing software for execution by the processor wherein the software allows a facilitator using facilitator device 206 connected to host controller 204 to share content to primary display 202. Facilitator device 206 may be connected to host controller 204 with a wireless or wired connection. Facilitator device 206 is shown as a tablet, but may be any type of digital device.

In embodiments, host controller 204 is also connected to network 208, so that devices in the room may share content to primary display 202. Host controller 204 may also be connected to a server or other network elements (not shown) over network 208. Host controller 204 may be an integrated component of display 202, such as a smart TV, or a separate device therefrom. Network 208 also connects primary display 202, either directly or via the host controller 204, with additional shared displays 210, 212 and 214. Facilitator device 206 uses a control application to control all shared displays in the room. The control application may be running on facilitators device 206 or on a separate device or tablet (not shown) connected to primary display 202 or host controller 204. A separate device may be provided as part of the infrastructure of the room, in embodiments.

As shown in FIG. 2, active learning environment 200 includes three shared displays 210, 212 and 214 for use by teams of students or collaborators. Students are associated in teams 222, 232 and 242 so they can dialog, problem solve and create new content together through the use of their client devices and a shared display for their group. Although three shared displays are shown, any number of shared displays may be provided. Further, client devices may by physically located in the room of the active learning environment, or remotely connected to one of the host controllers.

In an embodiment, shared display 210 is connected to host controller 216. Host controller 216 is similar to host controller 204 in that it includes a processor and memory storing software for execution by the processor. Host controller 216 provides a connection between shared display 210 and client devices 218, 220 used by members of user group or team 222 so that users may collaboratively share and manipulate content from their client devices 218, 220 on shared display 210. Client devices may connect to host controller 216 using a wired or wireless connection. The number of users in team 222 is flexible and limited only by the number of connection ports provided in host controller 216. Client devices may include, for example, any computing device, such as a laptop 218, tablet 220, or a mobile device (not shown).

Shared display 212 is connected to host controller 224. Client devices 226, 228 and 230 of user group or team 232 may collaboratively share and manipulate content on shared display 212. Client devices may connect to host controller 216 using a wired or wireless connection. The number of users in team 232 is flexible and limited only by the number of connection ports provided in host controller 224. Client devices may include, for example, any computing device, such as tablet 226, laptop 228, desktop computer 230 or a mobile device (not shown).

Shared display 214 is connected to host controller 234 so that client devices 236, 238 and 240 of user group or team 242 may collaboratively share and manipulate content on shared display 214. Client devices may connect to host controller 234 using a wired or wireless connection. The number of users in team 242 is flexible and limited only by the number of connection ports provided in host controller 234. Client devices may include, for example, any computing device, such as mobile device 236, laptops 238 and 240 or a desktop computer or tablet (not shown). In general, client devices shown in FIG. 2 are representative of the variety of devices that may be used in active learning environment 200 and do not indicate any specific arrangement of devices or preferred embodiment.

Host controllers 216, 224 and 234 also provide a connection between their connected shared displays 210, 212, 214 and network 208 so that users may cause content from any client device to be displayed on primary display 202. The facilitator may use facilitator device 206 to interact with host controller 204 to cause the content of any or all of shared displays 210, 212 and 214 to be shown on shared display 202. The facilitator may also cause content from shared display 202 to be shown on one or more of shared displays 210, 212 and 214. In embodiments, the facilitator may cause content from any client device in the room may be shown on any shared display in the room, as described in more detail below.

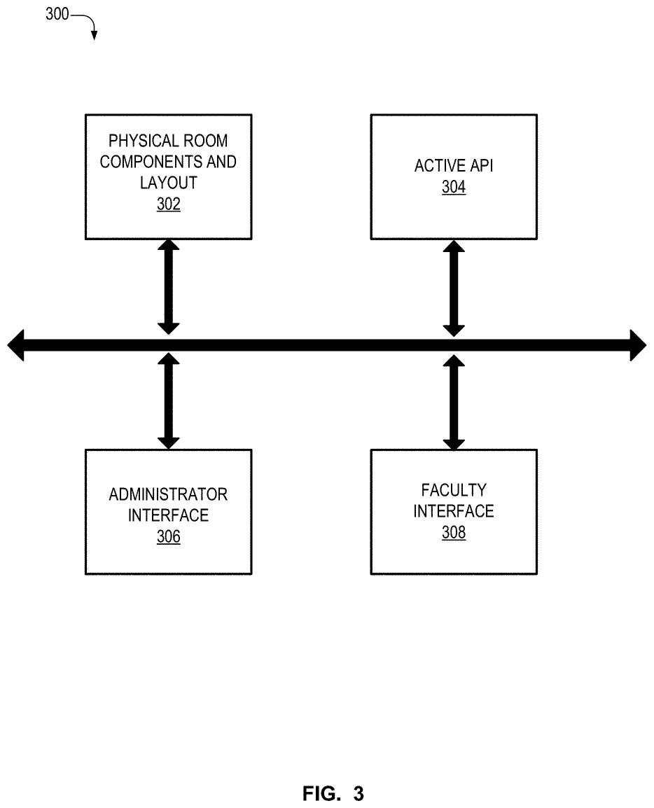

FIG. 3 is a block diagram representing components of an active learning system 300, in an embodiment. The block diagram is for purposes of discussion to clearly illustrate functions of system 300. Individual components may be embodied in hardware and/or software, and may be combined into a fewer number of components or split into additional components than those shown in FIG. 3.

An active learning system 300 may include several physical components 302. A typical active learning environment includes student team tables, seating, an optional front-of-room display or displays and various computing devices. It may also include cables or networking devices for connecting the components. The physical layout of a room is flexible and reconfigurable according to the needs of an active learning environment or a particular collaborative activity. In embodiments, active learning system 300 is corresponds to a physical layout but does not include physical objects such as tables or seating, for example, in a remote learning situation. When set up in a room, a shared display is located at each team table so that students may work collaboratively using digital content on client devices that have been connected to the shared display through a host controller, as described above in connection with FIG. 2.

Another component of an active learning system 300 is Active API (Application Programming Interface) 304. Active API 304 supports dynamic mirroring of one display to another. In an embodiment, Active API 304 provides a capability to readback, encode and transmit the content of a sender shared display via a network protocol, for example, TCP/IP (Transmission Control Protocol/Internet Protocol). Active API 304 also provides a capability to receive and decode streaming video at a receiver shared display.

Host controllers 204, 216, 224 and 234 of FIG. 2, for example, include an API that provides the capability to readback a display, encode some or all of the content shown on the display, and transmit it to another host controller over a network, which may be a local area network 208 as shown in FIG. 2 or more generally, the Internet. In embodiments, Active API 304 may be RESTful (Representational state transfer) and utilize host controller web services to trigger various events related to starting and stopping video routes. In addition, JSON (JavaScript Object Notation) formatting may be used in response to GET and POST HTTP calls.

Active API 304 may include a capability to cause host controllers to join an “Active Group.” In embodiments, a host controller may join up to three active groups, which may be tags that are carried in the discovery record of a host controller. A discovery record may be detected by client devices through, for example, a broadcast method or a network directory. Tags can be used to organize user-interfaces around the concept of Pods that can be managed via a single group.

Another capability provided by Active API 304 is video routing. A command to send video from a source host controller to a destination host controller uses, for example, an IP address of each host controller. Executing the command causes a source host controller to begin encoding its screen as a video. A TCP/IP socket is opened between the source and destination host controllers for video transmission. The display worksurface of the source host controller is then transmitted as a video to the destination host controller. The destination host controller receives the video, decodes and displays it on its connected shared display. If the source and destination host controllers are not in the same Active Group, then an error is returned. In addition, if the source is already sending to X destinations, then an error message may be generated.

In an embodiment, video content may be processed separately from audio content. A source host controller may encode and transmit a video to more than one shared display, each of which may decode and render the video. However, if the audio content is rendered at the same time, it may end up being played simultaneously at somewhat different rates around a room and creating confusion. Active learning system 300 provides a capability to define which host controller or controllers should receive audio. Further, host controllers may be designated as valid receivers of audio. In this situation, a sending host controller may encode and transmit both video and audio streams and transmit both streams to the destination host controller. In addition to decoding and rending the video stream, the destination host controller would decode and render the audio stream as well, replacing its own audio stream. If a destination host controller is not a valid audio receiver, system 300 has the capability to only send the video stream.

Separate processing of video and audio content may also provide for an active learning environment where a sophisticated audio system is installed. This may include one or more speakers that are audible to all users in the active learning environment. The audio system may be connected, for example, to host controller 204 coupled to primary display 202. A control interface (described in more detail below) may be allow a facilitator to cause audio streamed from any shared display to be is sent to host controller 204 for playing on the audio system. If content from shared display 212 is routed to shared display 214, for example, then audio would not necessarily be transmitted to the shared display 214. Instead, only when the video content may be sent to host controller 234 while audio content may be sent to host controller 204 and would play out of a single large room system audio. In embodiments, an audio system may be associated with any host controller in the room and audio may be dynamically associated with one or more host controllers while the room is in use.

In an embodiment, Active API 304, when sending and receiving video streams, may include additional information about what is displayed on a shared display. For example, a destination host controller receiving a video stream may add source information during a compositing phase that is then displayed on the receiving shared display. In addition, the source shared display may show destination information indicating what displays are currently receiving the source display content. In addition, source content may be displayed on the destination display in a variety of ways. The source may appear on the entire screen of the destination, with destination content invisible or faded out behind the source content. Split screen and tiling options are also available. In addition, a text message may be shown on a destination display as overlaying the current contents of the display with a fading or dimming effect. A timeout may be specified for text messages.

Other features may be provided by Active API 304, for example, ensuring that API calls will only operate on host controllers that have been assigned to at least one Active Group. Host controllers that are not members of an Active Group will return a failure code on calls other than ‘joinGroup’ and ‘leaveGroup’. Active API 304 may include a capability to stop sending video from a source to a destination, or to start or stop video from a source to multiple destinations.

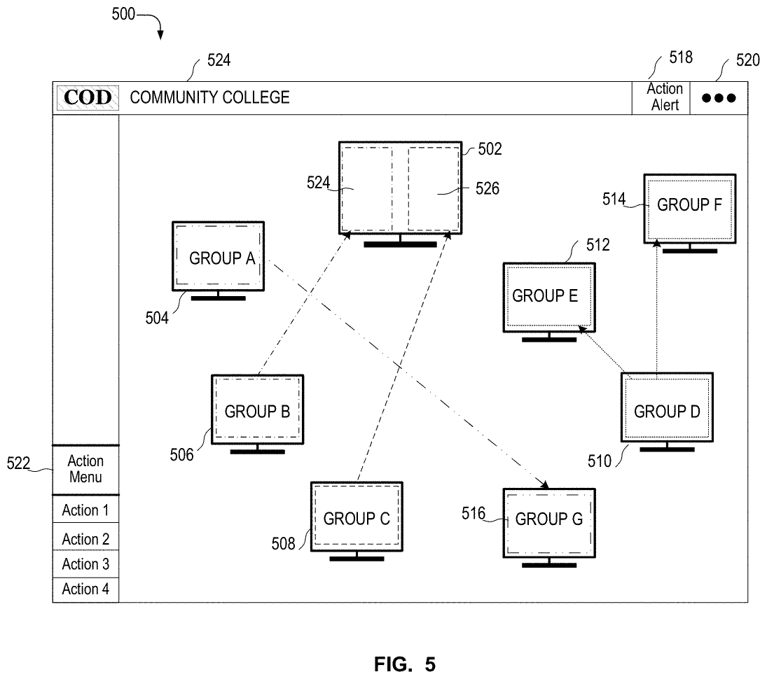

Another component of active learning system 300 is administrator interface 306, a tool used by administrators and facility managers to create an active learning room by creating a digital representation of a physical room, or control interface, including shared displays and other equipment. Administrator interface 306 provides a simple mechanism to design a control interface on a per-room basis so that a user who later logs in to use the space will see an intuitive interface that has been designed for the room, as will be described in more detail in connection with FIG. 5. In embodiments, designing a control interface may include several steps. First, an administrator may select a rough “shape” for the room to be presented—rectangle, square, L-shaped, 3 walls with an open area (nook). An administrator may also add one or more doorways or other physical features of the room. This allows users to orient themselves and correlate components in the control interface with physical components in the room. more easily. An administrator may also select representations of tables/chairs, screens, etc. from a shape library and position them in the room. As a further step, an administrator may select a scale factor that scales all elements within the walls to denote the general size of the room, for example, a typical classroom with 3-6 team tables, a small study space in a library, for example, or a large presentation space or auditorium).

Once a general layout of a room is designed, a representation of each of shared displays/host controller is placed in the room in locations representative of its physical location in the room. By defining the spatial arrangement of the various host controllers/shared displays, the control interface defines interactions between a user and the system. Administrator interface 306 may also be used to restrict what routes can be enabled between tables, for example, shared displays may be restricted to only sharing to the front of the room.

Shared displays in an active learning room may be referred to as routable endpoints because they may serve as the source or destination of content. Shared displays 202, 210, 212, 214 in FIG. 2 are examples of shared displays. Drag and drop icons may be used in creating a control interface for room. In an embodiment, non-routable endpoints, such as tables and chairs, may be interactive as well. For example, a chair may light up on the control interface when a student asks a question or to give an indication of engagement level of a student. Because a control interface is a spatial representation, a user of a control interface may align the interface to specific teams and even students in the space.

A control interface may be designed to include “temporal” controls and shortcuts with assigned names. For example, an interface button called “Take your Seats” may trigger a specific multiscreen message, then transition to showing the front of room display on all screens. The interface button may include a sequence of options, including a “next” button that caused a message such as “Work as a Team” to be displayed that simply stops sharing between teams, followed by “5 minutes left.” This representative type of ‘script’ may be used to design how the class is expected to flow and leverage the layout with shortcuts to make operation of the control interface simple. Many other scripts and actions are possible.

Further, the control interface of a room is easily reconfigurable. If the furniture of a room is changed, an administrator interface allows administrators and facility managers to define multiple layouts for a room, which may then be selected by faculty users based on the current layout of the room.

In addition to creating control interfaces for active learning spaces, administrator interface 306 may provide other management tools. One of these tools may include a user role setup mechanism. Users, both students and faculty, may be added to the system as account holders and registered users may be provided with login procedures. The creation of user accounts allows users to set profiles containing user-specific settings that may be used in any active learning room in the facility and stored for future use. A number of different user accounts may be provided with different levels of access to the system. For example, in addition to “Teacher” and “Student” accounts, a “Kiosk” account may be created by an administrator. A kiosk user is different in that they cannot add routes/customize the interface and a “logout” capability is not presented—this is important so that a tablet bolted to a wall can always be in the room for use.

Faculty interface 308 is a tool for interacting with a control interface that may be created using the administrator interface 306. Faculty interface 308 allows teachers to drag-and-drop representations of shared displays within the learning space to control what content is shown on each display. A teacher beginning a session in a room logs into a user account using a tablet or client device connected to a host controller. A list of available rooms may be presented, including more than one defined control interfaces for some rooms. Alternatively, a tablet may be assigned permanently to the room, or a client device may detect which room it is located in and provide control interface selections to the teacher. Once a control interface is selected, the teacher may interact with the control interface to control the routing of video and other content between displays in the room. A gestural interface allows the teacher to, for example, drag the visual representation in the control interface of a source display to a destination display to cause the screen of the source display to be shown on the destination display.

The teacher may also interact with the control interface to send messages to one or more of the displays by selecting a message to be broadcast/transmitted—this message pauses the local sharing to overlay a message on the display. The teacher may request a live view of what's on the screen at any of the shared displays in the room on the teacher's client device. The teacher may also perform other administrative tasks such as adding built-in messages, or video sharing routes, that can be saved/recalled in the teacher's user account.

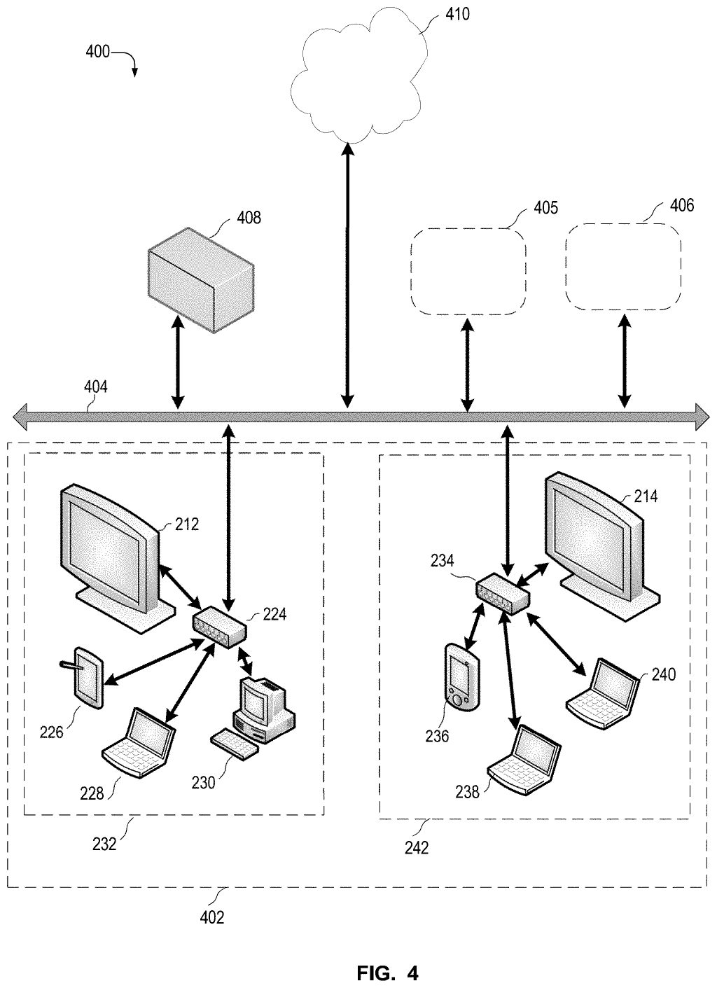

FIG. 4 is a diagram of a facility 400 with more than one active learning room. Active learning room 402 includes teams 232 and 242 with their associated components as shown in FIG. 2. Although teams 232 and 242 are shown, active learning room 402 may also include other components from FIG. 2, such as team 222 and primary display 202.

Host controllers 224 and 234 are connected to network 404. In an embodiment, network 404 is a wired or wireless network using a TCP/IP communication protocol where devices in the network are assigned IP addresses. Further, network 404 may include multiple networks, just as a user network, a facilitator network and an AV/room network. Network ports on all devices included in the active learning environment may be configured to facilitate routable TCP traffic between devices.

Facility 400 may include additional active learning rooms 405 and 406. Any number of active learning rooms may be provided with the same or different configurations as discussed herein. Local switch 408 is connected to network 404 and facilitates interaction between all components and networks in facility 400. Switch 408 also connects with any of a variety of other components 410. This may include cloud storage such as a server physically located in the facility or accessible over the internet. Components 410 store account and configuration data for the administration and use of active learning rooms 402, 405 and 406. In addition, runtime information is stored in the cloud, for example, when a user adds a custom message, it is stored in the user-specific storage and is present whenever that user logs into their account from the app—even on different devices. Components 410 also manages user roles and supports authentication.

In an embodiment, any number of active learning rooms may be provided in a facility. In an embodiment, network traffic uses the TCP/UDP routing standard, although any suitable network protocol may be used. Further, any component of an active learning room or active learning facility 400 may transmit video and/or audio to a device that is operating video conferencing software so that the video/audio may be shared with remote users through a video conferencing application, for example, Zoom.

FIG. 5 is a representation of a graphical user interface (GUI) for use by an administrator or facilitator with an active learning facility. It may be used with components of either or both of administrator interface 306 or faculty interface 308 of FIG. 3. GUI 500 depicts a specific embodiment of an active learning environment but embodiments are not limited to this diagram. GUI 500 includes several fields for displaying information and menus for interacting with GUI 500. Field 524 displays a name or identification of the active learning facility for example, a community college. Other identifying information, such as a facilitator name or classroom number may also be displayed. Field 518 displays one or more actions by participants in the active learning environment, such as raising a hand or submitting a question. Fields 520 and 522 provides access to additional fields or menu items for use by an administrator or facilitator when setting up or controlling an active learning environment.

GUI 500 as shown in FIG. 5 represents an active learning environment, or room, with includes a primary shared display 502 and seven shared displays 504, 506, 508, 510, 512, 514 and 516. Each shared displays represents a Group A-G of one or more students who are connected to the shared display by a host controller which is coupled to a network, as shown in FIG. 2. The physical connection between components may be wired or wireless.

As depicted, primary shared display 502 is displaying content from both shared display 506 and shared display 508. Content from shared display 506 appears in field 524 of primary shared display 502 while content from shared display 508 appears in area 526. As shown in FIG. 5, content from shared display 510 is routed to both shared displays 512 and 514. Similarly, the representation of shared display 504 is routed to shared display 516. Although specific routings are shown in FIG. 5, these are by way of example only. Other routings are contemplated as described below.

GUI 500 provides drag-and-drop control to allow an administrator or facilitator to easily change the content of each display. For example, the representation of shared display 510 may be selected in GUI 500, then dragged to the representations of both shared displays 512 and 514 to cause the content of corresponding shared displays in the active learning environment to be shared accordingly.

In an embodiment, the routing capabilities within an active learning room include “show this on that” where one display may be dragged to another display, “show this everywhere” where a specified display may be shown on all displays in the room, “show this on front” where a specific display may be shown on the primary display in the room, and “reset.” Other routing capabilities may also be defined and accessible through menus in fields 520 and 522.

In addition to mirroring one display on another, an active learning system in an embodiment also renders meta data on both the sender shared display and receiver shared display. For example, the physical shared displays corresponding to 506 and 508 may include the legend “Sending to primary display” while the shared display corresponding to 502 may include the legend “Receiving from Group B and Group C.” Messages like this help orient students and teachers in an active learning environment.

Action menu 522 on the left side of GUI 500 provides additional features to a user of faculty interface 308. A user may use shortcuts to quickly change the content of shared displays, including “all eyes on front” and “show primary screen everywhere.” Action menu 522 also provides a mechanism for a teacher to send a message to all displays in the space, for example “Look up Front” or “Five minutes remaining.” Additional shortcuts may be defined by the user.

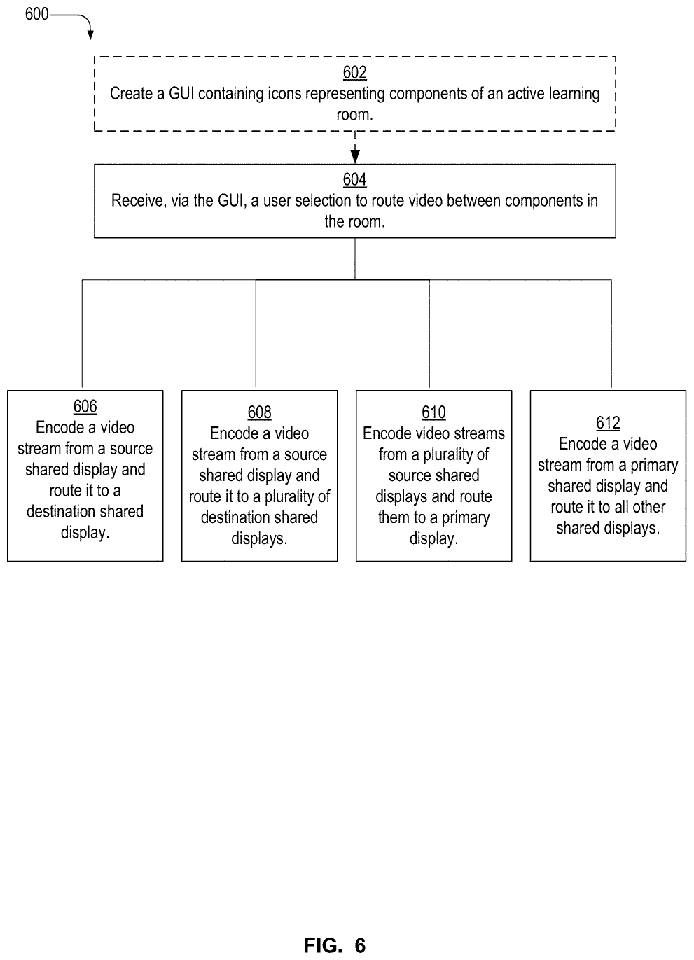

FIG. 6 is a flowchart illustrating a method 600 of routing video streams using the GUI of FIG. 5. Method 600 includes steps 604 and any of steps 606, 608, 610 and 612. In embodiments, method 600 also includes step 602.

Step 602 includes creating a GUI representing components of an active learning room. In an example of step 602, an administrator enters identifying information for the active learning room, such as a room number or class identifier. The administrator selects a room shape that approximates the shape of the active learning room. The administrator then designs the GUI to match the physical layout of the room by selecting icons that match components such as a primary display and one or more shared displays and positioning them in the GUI at a location approximately the same as their location in the room. Other fixtures such as chairs and tables or doors and windows may also be added to the GUI to aid in creating an accurate representation of the room.

Step 604 includes using the GUI by a facilitator during a classroom session to route video streams between shared displays. In an example of step 604, a facilitator may cause the GUI to be displayed on user interface or facilitator device 206. The facilitator may use various combinations of movements to interact with the GUI to control video routing between shared displays. These interactions include press-and-hold on an icon and drag-and-drop an icon to another icon.

Step 606 includes encoding a video stream from a source shared display and routing it to a destination shared display. In an example of step 606, a user selection in step 604 causes a command to be sent to a host controller attached to shared display 504, for example. The host controller encodes the contents of the shared display 504 into a video stream and routes the video stream to a shared display 516, for example.

Step 608 includes encoding a video stream from a source shared display and routing it to a plurality of destination shared displays. In an example of step 608, a user selection in step 604 causes a command to be sent to a host controller attached to shared display 510, for example. The host controller encodes the contents of shared display 510 into a video stream and routes the video stream to shared displays 512 and 514. In embodiments, the video stream may also be routed to shared displays 504, 506, 508 and 516 as well as primary shared display 502 simultaneously.

Step 610 includes encoding a video stream from a plurality of source shared displays and routing them to a primary shared display. In an example of step 610, a user selection in step 604 causes a command to be sent to host controllers attached to shared displays 506 and 508, for example. The host controller encodes the contents of shared display 506 and 508 into video streams and routes the video streams to primary shared display 502 simultaneously.

Step 612 includes encoding a video stream from a primary shared display and routing it to a plurality of shared display. In an example of step 612, a user selection in step 604 causes a command to be sent to a host controller attached to primary shared display 502, example. The host controller encodes the contents of primary shared display 502 into a video stream and routes the video stream to all or some of shared displays 504, 506, 508, 512, 514 and 516 simultaneously.

Active learning environments typically include multiple displays, each of which may be controlled by a host controller and interconnected by a network. The host controllers may provide an interface or connection points for users to connect an individual computing device to the display. Active learning environments increase student engagement, facilitate content sharing and collaboration within and across groups of students, connect faculty or moderators with their students and leverage multi-screen environments to meet teaching and learning goals.

### Combinations of Features

Features described above as well as those claimed below may be combined in various ways without departing from the scope hereof. The following enumerated examples illustrate some possible, non-limiting combinations:

(A1) A method of sharing video content between a plurality of shared displays coupled to a network by a respective plurality of host controllers, wherein content from a plurality of client devices coupled to a host controller is shared to its respective shared display, each host controller comprising a processor and a memory storing instructions that when executed by the processor perform the method including receiving a command at a first source host controller from a user interface device coupled to the network, the command indicating that the content of a first source shared display coupled to the first source host controller should be displayed on a first destination shared display; encoding the first source shared display contents as a first source video; and streaming the first source video over the network to the first destination shared display.

(A2) In method (A1), the method includes receiving the first source video stream at a first destination host controller coupled to the first destination shared display; and displaying the first source video stream on the first destination shared display.

(A3) In any of methods (A1)-(A2), the method includes receiving a command at a second source host controller from the user interface device, the command indicating that the content of a second source shared display coupled to the second source host controller should be displayed on a second destination shared display; encoding the second source shared display contents as a second source video; and streaming the second source video over the network to the second destination shared display.

(A4) In method (A3), the method includes receiving a command at a second source host controller from the user interface device, the command indicating that the content of the second source shared display should be displayed on a third destination shared display; receiving the second source video stream at the host controller coupled to the third destination shared display; and controllably displaying the second source video streams on both the second destination shared display and the third destination shared display.

(A5) In any of methods (A1)-(A4), the method includes displaying information identifying the first source shared display on the first destination shared display.

(A6) In any of methods (A1)-(A5), the method includes displaying information identifying the first destination shared display on the first source shared display.

(A7) In any of methods (A1)-(A6), the method includes routing the first source video stream over the network to a plurality of destination displays.

(A8) In any of methods (A1)-(A7), the method includes receiving a command from the user interface device representing a text message and a destination shared display; and displaying the text message on the destination shared display.

(B1) A multi-tiered display system for sharing content between a plurality of client includes a network; a first host controller coupled to the network, the first host controller further coupled to a first shared display and one or more first client devices sharing content to the first shared display; a second host controller coupled to the network, the second host controller further coupled to a second shared display and one or more second client devices sharing content to the second shared display; a user interface device coupled to the network, the user interface device further comprising a processor and a memory storing instructions that when executed by the processor operate to: display a representation of the first and second shared displays in a graphical user interface (GUI); receive an input to the GUI to route content from the first shared display as a source to the second shared display as a destination; and send a command to the first host controller to encode the contents of the first shared display and stream it over the network to the second host controller.

(B2) In system (B1), the system further comprising a third host controller coupled to the network, a third shared display and one or more third client devices, the processor executing instructions stored in the memory to: receive an input to the user interface to route content from the first shared display as a source to the third shared display as a destination; and send a command to the first host controller to encode the contents of the first shared display and stream it over the network to the third host controller.

(B3) In any of systems (B1)-(B2), a primary shared display coupled to the network by a primary host controller, the processor executing instructions stored in the memory to: receive an input to the user interface to route content from the first and second shared displays to the primary shared display; and send a command to the first and second host controllers to encode the contents for the first and second shared displays and stream them to the primary host controller.

(B4) In any of systems (B1)-(B3), an audio system for receiving an audio stream, the processor executing instructions stored in the memory to: encode the shared display contents into separate audio and video streams; and streaming the audio stream over the network to the audio system and streaming the video stream over the network to a destination shared display.

(C1) A method of routing video streams between shared displays using a graphical user interface (GUI), the GUI displaying a representation of a plurality of shared displays each displaying content from one or more client devices coupled to a respective shared display, including receiving, via the GUI, a user selection to route content from a first shared display to a second shared display; encoding the contents of the first shared display into first video stream; and routing the first video stream to the second shared display.

(C2) In method (C1), the plurality of shared displays comprises at least three displays, the method further comprising: receiving, via the GUI, a user selection to route content from the first shared display to all shared displays; encoding the contents of the first shared display into first video stream; and routing the first video stream to the all shared displays.

(C4) In any of methods (C1)-(C2), one of the shared displays is a primary shared display, the method further comprising: receiving, via the GUI, a user selection to route content from the primary shared display to all shared displays; encoding the contents of the primary shared display into a primary video stream; and routing the primary video stream to the all shared displays.

(C5) In the method of (C4), the method including receiving, via the GUI, a user selection to route content from a plurality of shared displays to the primary shared display; encoding the contents of the plurality of shared displays into a plurality of video streams; and routing the plurality of video streams to the primary shared display.

(C6) In any of methods (C1)-(C5), the method including receiving, via the GUI, a user selection to display a text message on at least one shared display; receiving, via the GUI, a message content and a destination shared display; and routing the message from the user interface to the destination shared display.

(C7) In method (C6), the method also including receiving, via the GUI, a user selection to display a text message on all shared displays; receiving, via the GUI, a message content; and routing the message from the user interface to all shared displays.

Changes may be made in the above system, methods or device without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A method of sharing video content between a plurality of shared displays coupled to a network by a respective plurality of host controllers, wherein content from a plurality of client devices coupled to a host controller is shared to its respective shared display, each host controller comprising a processor and a memory storing instructions that when executed by the processor perform the method comprising:
receiving a command at a first source host controller from a user interface device coupled to the network, the command indicating that the content of a first source shared display coupled to the first source host controller should be displayed on a first destination shared display;
encoding the first source shared display contents as a first source video; and
streaming the first source video over the network to the first destination shared display.

2. The method of claim 1, further comprising:
receiving the first source video stream at a first destination host controller coupled to the first destination shared display; and
displaying the first source video stream on the first destination shared display.

3. The method of claim 1, further comprising:
receiving a command at a second source host controller from the user interface device, the command indicating that the content of a second source shared display coupled to the second source host controller should be displayed on a second destination shared display;
encoding the second source shared display contents as a second source video; and
streaming the second source video over the network to the second destination shared display.

4. The method of claim 3, further comprising:
receiving a command at a second source host controller from the user interface device, the command indicating that the content of the second source shared display should be displayed on a third destination shared display;
receiving the second source video stream at the third destination shared display; and
controllably displaying the second source video stream on both the second destination shared display and the third destination shared display.

5. The method of claim 1, further comprising displaying information identifying the first source shared display on the first destination shared display.

6. The method of claim 1, further comprising displaying information identifying the first destination shared display on the first source shared display.

7. The method of claim 1, further comprising routing the first source video stream over the network to a plurality of destination displays.

8. The method of claim 1, further comprising:
receiving a command from the user interface device representing a text message and a destination shared display; and
displaying the text message on the destination shared display.

9. A multi-tiered display system for sharing content between a plurality of client devices, comprising:
a network;
a first host controller coupled to the network, the first host controller further coupled to a first shared display and one or more first client devices sharing content to the first shared display;
a second host controller coupled to the network, the second host controller further coupled to a second shared display and one or more second client devices sharing content to the second shared display; and
a user interface device coupled to the network, the user interface device further comprising a processor and a memory storing instructions that when executed by the processor operate to:
display a representation of the first and second shared displays in a graphical user interface (GUI);
receive an input to the GUI to route content from the first shared display as a source to the second shared display as a destination; and
send a command to the first host controller to encode the contents of the first shared display and stream it over the network to the second host controller.

10. The multi-tiered display system of claim 9, further comprising a third host controller coupled to the network, a third shared display and one or more third client devices, the processor executing instructions stored in the memory to:
receive an input to the user interface device to route content from the first shared display as a source to the third shared display as a destination; and
send a command to the first host controller to encode the content of the first shared display and stream it over the network to the third host controller.

11. The multi-tiered display system of claim 9, further comprising:
a primary shared display coupled to the network by a primary host controller, the processor executing instructions stored in the memory to:
receive an input to the user interface device to route content from the first and second shared displays to the primary shared display; and
send a command to the first and second host controllers to encode the content for the first and second shared displays and stream them to the primary host controller.

12. The multi-tiered display system of claim 9, further comprising an audio system for receiving an audio stream, the processor executing instructions stored in the memory to:
encode the shared display content into separate audio and video streams; and
streaming the audio stream over the network to the audio system and streaming the video stream over the network to a destination shared display.

13. A method of routing video streams between shared displays using a graphical user interface (GUI), the GUI displaying a representation of a plurality of shared displays each displaying content from one or more client devices coupled to a respective shared display, comprising:
receiving, via the GUI, a user selection to route content from a first shared display to a second shared display;
encoding the contents of the first shared display into first video stream; and
routing the first video stream to the second shared display.

14. The method of claim 13, wherein the plurality of shared displays comprises at least three displays, the method further comprising:
receiving, via the GUI, a user selection to route content from the first shared display to all shared displays;
encoding the content of the first shared display into first video stream; and
routing the first video stream to the shared displays.

15. The method of claim 13, wherein one of the shared displays is a primary shared display, the method further comprising:
receiving, via the GUI, a user selection to route content from the primary shared display to all shared displays;
encoding the content of the primary shared display into a primary video stream; and
routing the primary video stream to the shared displays.

16. The method of claim 15, further comprising:
receiving, via the GUI, a user selection to route content from a plurality of shared displays to the primary shared display;
encoding the content of the plurality of shared displays into a plurality of video streams; and
routing the plurality of video streams to the primary shared display.

17. The method of claim 13, further comprising:
receiving, via the GUI, a user selection to display a text message on at least one shared display;
receiving, via the GUI, a message content and a destination shared display; and
routing the text message to the destination shared display.

18. The method of claim 17, further comprising:
receiving, via the GUI, a user selection to display a text message on all shared displays;
receiving, via the GUI, a message content; and
routing the text message to all shared displays.
